(19) United States
(12) Patent Application Publication
(10) Pub. No.: US 2010/0070304 A1
(43) Pub. Date: Mar. 18, 2010

(54) SYSTEM AND METHOD FOR RECOGNIZING MEDICATION SIDE EFFECTS IN PATIENTS

(76) Inventor: Stephen Ronald Levinson, Easton, CT (US)

Correspondence Address: WIGGIN AND DANA LLP;ATTENTION: PATENT DOCKETING, ONE CENTURY TOWER, P.O. BOX 1832, NEW HAVEN, CT, 06508-1832, US

(21) Appl. No.: 12/211,136

(22) Filed: Sep. 16, 2008

(51) Int. Cl. G06Q 50/00; G06Q 10/00; G06F 7/06; G06F 17/30

(52) U.S. Cl. 705/3; 707/E17.014

(57) ABSTRACT

A system for automatically correlating a patient's symptom with medication side effects includes: a computing device for use by medical personnel to input and display data; a first database including an electronic health record (EHR) for the patient; a second database including Physician's Desk Reference (PDR) data regarding side effects of medications; and a server configured to receive information from the computing device regarding the symptom; retrieve a list of the patient's medications from the first database; obtain a record of recognized side effects of those medications from the second database; and transmit a message to the computing device regarding medications and side effects correlated with the symptom.

### FIELD OF THE DISCLOSURE

This disclosure relates to a system for comparing patients' presenting medical symptoms with recognized side effects of their current medications, to assist physicians in more comprehensively evaluating the symptoms and including these side effects as a component of the physician's differential diagnosis of the causes of patients' problems.

### BACKGROUND OF THE DISCLOSURE

A physician has a responsibility to evaluate each patient's presenting symptoms, ascertain whether there is an immediate danger to health and well being, and then (once immediate safety has been assured) identify the underlying cause of the patient's problem and initiate appropriate management. Physicians are trained to employ the medical diagnostic process, a logical approach that combines an effective medical history, physical examination, and diagnostic testing with knowledge and experience related to the natural course of multiple disease processes.

Successful use of this diagnostic process requires physicians to be aware of most of the potential causes of patients' problems. One important and common cause of patients' presenting symptoms is the side effects of medications. Many medications manifest side effects in areas of the body that are completely unrelated to the condition they are used to treat; for example, medications employed to lower serum cholesterol levels (statin medications) may have side effects ranging from memory loss to erectile dysfunction. Many categories of pharmaceuticals that are targeted to treat specific illnesses have effects on multiple systems throughout the human body.

Unfortunately, the connection between a patient's presenting symptoms and medication side effects is often overlooked or not properly investigated. Physicians frequently fail to consider side effects as a primary etiology for patient symptoms because of the excessive volume of potentially relevant information required to process these possibilities within the time-restricted encounters in the current health care environment. The Physician's Desk Reference (PDR), the recognized authoritative reference on medications, is nearly 3,500 pages in length. The section on a widely prescribed statin medication, for example, has five full pages of written description and tables equivalent to approximately 12,000 words of text. The magnitude of the challenge physicians face in identifying side effects as a potential etiology of their patients' symptoms is illustrated by the fact that the PDR lists a total of 144 different potential side effects for the commonly prescribed statin medication Atorvastatin. Even if a patient meeting a physician is known to be taking this medication, in the time available during an encounter, the physician is not likely to be able to review all of this information manually and in detail, and therefore may frequently not consider side effects in his differential diagnosis of the patient's problems. There is a need for a system which can make medication side effect information more readily accessible to the physician, and thereby (in many instances) eliminate the risks associated with various radiologic and diagnostic procedures and save unnecessary medical costs.

### SUMMARY OF THE DISCLOSURE

The present disclosure provides a method for correlating medication side effects with a patient's symptom, including receiving information regarding the symptom via a computing device; retrieving a list of the patient's medications; accessing a record of recognized side effects of the medications; comparing the record with the symptom; identifying medications and side effects thereof correlating with the symptom; and transmitting a message including the correlated medications and side effects. The received information may include a time of onset of the symptom, and/or a medication with a date that medication was started by the patient. The patient's medical history may also be retrieved, and the history updated regarding the symptom. The method may also include accessing a thesaurus to generate a list of synonyms for the symptom, and for the recognized side effects; the lists of synonyms may then be compared.

In an embodiment of the disclosure, the list of medications is included in an electronic health record (EHR) of the patient, and the record of side effects is included in a Physician's Desk Reference (PDR) database.

In accordance with another aspect of the disclosure, a system for automatically correlating a patient's symptom with medication side effects includes: a computing device for use by medical personnel to input and display data; a first database including an electronic health record (EHR) for the patient; a second database including Physician's Desk Reference (PDR) data regarding side effects of medications; and a server configured to receive information from the computing device regarding the symptom; retrieve a list of the patient's medications from the first database; obtain a record of recognized side effects of those medications from the second database; and transmit a message to the computing device regarding medications and side effects correlated with the symptom.

The foregoing has outlined, rather broadly, the preferred features of the present disclosure so that those skilled in the art may better understand the detailed description of the disclosure that follows. Additional features of the disclosure will be described hereinafter that form the subject of the claims of the disclosure. Those skilled in the art should appreciate that they can readily use the disclosed conception and specific embodiment as a basis for designing or modifying other structures for carrying out the same purposes of the present disclosure and that such other structures do not depart from the spirit and scope of the disclosure in its broadest form.

### BRIEF DESCRIPTION OF THE DRAWINGS

FIG. 1 is a schematic illustration of a patient visit with a physician, where the physician uses a system embodying the disclosure to diagnose a patient's condition.

FIG. 2 is a flowchart of steps in a process for evaluating a patient's symptoms, including identifying side effects of the patient's medications.

FIG. 3 is a schematic illustration of a system according to an embodiment of the disclosure, showing inputs to the system from a physician, medical history data from a patient EHR and side effect data obtained from a PDR database.

### DETAILED DESCRIPTION

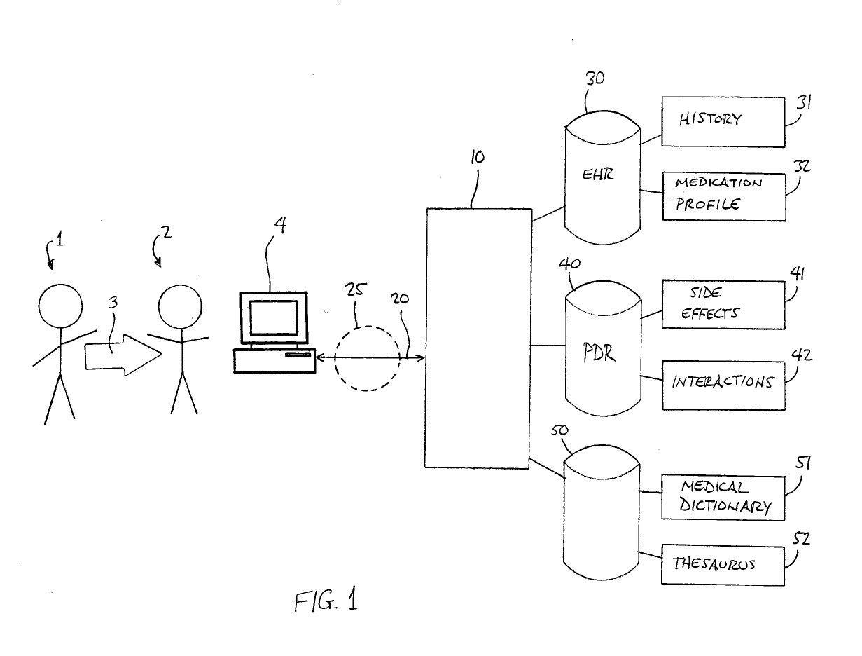

FIG. 1 illustrates an embodiment of the disclosure where a patient 1, meeting with a physician 2, presents symptoms 3 to the physician. The physician uses a terminal 4 (typically a personal computer) to communicate with a server 10 over a communication link 20. The communication link may be a direct link, or alternatively involve a communication path via a network 25 such as the Internet. Software (described in more detail below) executing on server 10 causes the server to access several collections of data. The patient's Electronic Health Record (EHR), stored on database 30, includes the patient's medical history 31 and a list 32 of medications in the patient profile, which will have been updated on the date of this visit. The PDR database 40 includes data 41 on the side effects of all medications listed in the PDR, and additional data 42 regarding interactions between medications. Another database 50 includes a medical dictionary 51 and a medical thesaurus 52, to provide a more comprehensive linkage of the medical history language in the EHR with the description of side effects in the PDR.

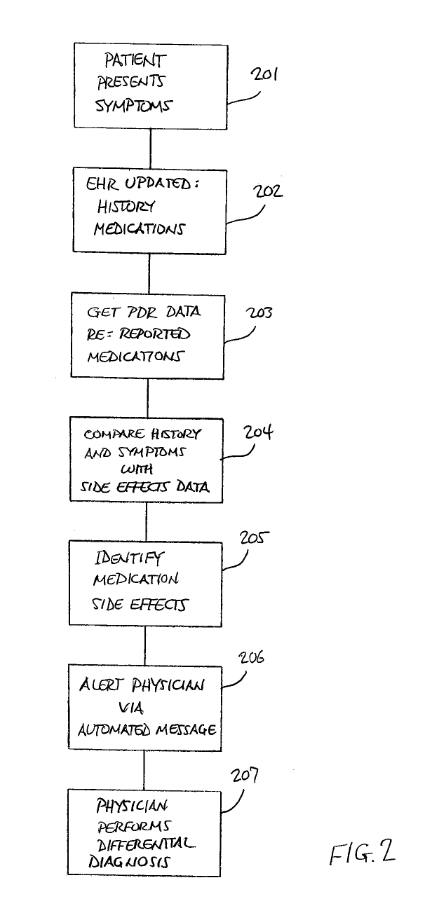

FIG. 2 shows a flowchart of a patient encounter with the physician. The patient 1 presents symptoms 3 (step 201). Using terminal 4, physician 2 updates the patient's history and list of medications in the EHR, and documents the patient's chief complaint (as of the date of the visit) and a detailed review of the patient's symptoms (step 202). In an embodiment, the software executing on server 10 automatically starts upon completion of this update. The software accesses the PDR database 40 and the EHR database 30 to retrieve data regarding side effects of the medications listed in the patient's profile (step 203). The software proceeds to automatically cross-reference positive responses in the medical history 31 (including the presenting symptoms) with the PDR side effects data 41 for the listed medications (step 204), facilitated by the medical dictionary and thesaurus 50. The software identifies any of the patient's medications with recognized side effects that might be the etiology of the patient's symptoms (step 205). The software then causes display of a message to the physician, alerting the physician of the relevant medications and side effects (step 206). In an embodiment, this alert message may be a pop-up window on the display of terminal 4. The physician then includes this information in compiling a comprehensive differential diagnosis of the patient's problem (step 207).

In this embodiment, the cross-referencing of PDR data and EHR history and medication data is initiated automatically upon completion of the update by the physician. The software performs an automated comparison of the patient's symptoms and history with side effects of the patient's medications, whether or not a new medication is prescribed during the visit. The alert message may be sent to the physician during the patient's visit. In contrast, a manual review of the PDR by the physician or his nursing staff might require fifteen minutes or more, too long to permit identification of potential side effect etiologies with the patient during the same visit.

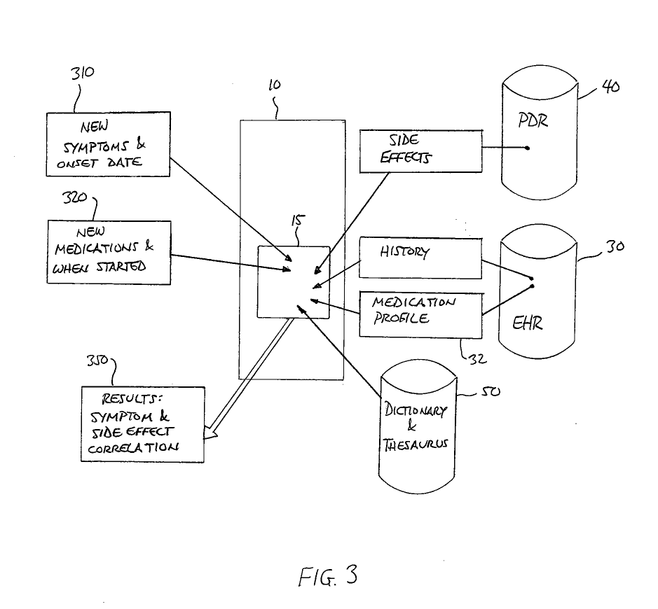

In an embodiment, the software may be characterized as a comparison engine 15 for comparing recognized side effects of the patient's medication with the presented symptoms. As shown schematically in FIG. 3, inputs to the comparison engine (provided by the physician via terminal 4 over communication link 20) include new symptoms 310 and any new medications 320 (that is, medications not yet listed in the patient's medication profile 32), together with the date the symptoms began and the date the medication was started. Other inputs to engine 15 include the side effects of the medications (both new and already listed) from PDR database 40, and the medical history and medication profile from EHR database 30. In an embodiment, the engine 15 also generates a list of synonyms of the symptoms and medications using the dictionary and thesaurus 50, so that the comparison covers various synonyms for the symptoms, medications and side effects.

The comparison engine 15 then generates a list 350 of those medications (whether in the patient profile or newly reported, under the listed name or synonyms thereof) whose side effects, and the date the patient began the medication, are consistent with the symptoms presented. In an embodiment, the correlation list of symptoms and medication side effects is displayed to the physician as part of the alert message. Each item on the list (that is, a medication correlated with a presented symptom) may include a citation to the precise location in the PDR, so that the information may be verified by the physician.

While the disclosure has been described in terms of specific embodiments, it is evident in view of the foregoing description that numerous alternatives, modifications and variations will be apparent to those skilled in the art. Accordingly, the disclosure is intended to encompass all such alternatives, modifications and variations which fall within the scope and spirit of the disclosure and the following claims.

I claim:

1. An automated method for correlating medication side effects with a patient's symptom, comprising:
receiving information regarding the symptom via a computing device;
retrieving a list of medications associated with the patient;
accessing a record of recognized side effects of the medications;
comparing the record with the symptom;
identifying medications and side effects thereof correlating with the symptom; and
transmitting a message including the correlated medications and side effects.

2. A method according to claim 1, wherein the received information further includes at least one of:
a time of onset of the symptom; and
a medication, with a date that medication was started by the patient.

3. A method according to claim 1, wherein said retrieving step further comprises retrieving the patient's medical history.

4. A method according to claim 3, further comprising updating the medical history regarding the symptom.

5. A method according to claim 1, further comprising:
prior to said comparing step, accessing a thesaurus to generate a list of synonyms for the symptom, and for the recognized side effects,
and wherein said comparing step includes comparing the list of synonyms for the symptom with the list of synonyms for the recognized side effects.

6. A method according to claim 1, wherein the list of medications is included in an electronic health record (EHR) of the patient, and the record of side effects is included in a Physician's Desk Reference (PDR) database.

7. A method according to claim 6, wherein the message further includes a citation to the PDR of the side effects, thereby facilitating non-automated verification of the message.

8. A system for automatically correlating a patient's symptom with medication side effects, comprising:
a computing device for use by medical personnel to input and display data;
a first database including an electronic health record (EHR) for the patient,
a second database including Physician's Desk Reference (PDR) data regarding side effects of medications; and
a server configured to
receive information from the computing device regarding the symptom;
retrieve a list of medications associated with the patient from the first database;
access the second database to obtain a record of recognized side effects of the medications;
compare the record with the symptom;
identify medications and side effects thereof correlating with the symptom; and
transmit a message to the computing device including the correlated medications and side effects.

9. A system according to claim 8, wherein the received information further includes a time of onset of the symptom.

10. A system according to claim 8, wherein the received information further includes a medication and a date the medication was started by the patient.

11. A system according to claim 8, wherein the server is configured to retrieve the patient's medical history from the first database.

12. A system according to claim 11, wherein the server is configured to update the medical history regarding the symptom.

13. A system according to claim 8, further comprising a third database including a medical thesaurus, and wherein the server is configured to
access the third database to obtain synonyms for the symptom and for the recognized side effects;
generate a first list of synonyms for the symptom and a second list of synonyms for the recognized side effects, and
compare the first list with the second list.

14. A system according to claim 8, wherein the server is configured to include in the message a citation to the PDR of the side effects, thereby facilitating non-automated verification of the message.

15. A computer-readable medium having stored therein instructions for performing a method, the method comprising:
receiving information regarding the symptom via a computing device;
retrieving a list of medications associated with the patient;
accessing a record of recognized side effects of the medications;
comparing the record with the symptom;
identifying medications and side effects thereof correlating with the symptom; and
transmitting a message including the correlated medications and side effects.

16. A computer-readable medium according to claim 15, wherein the received information further includes at least one of:
a time of onset of the symptom; and
a medication, with a date that medication was started by the patient.

17. A computer-readable medium according to claim 15, wherein in said method the retrieving step further comprises retrieving the patient's medical history.

18. A computer-readable medium according to claim 17, said method further comprising updating the medical history regarding the symptom.

19. A computer-readable medium according to claim 15, said method further comprising:
prior to said comparing step, accessing a thesaurus to generate a list of synonyms for the symptom, and for the recognized side effects,
and wherein said comparing step includes comparing the list of synonyms for the symptom with the list of synonyms for the recognized side effects.

20. A computer-readable medium according to claim 15, wherein the list of medications is included in an electronic health record (EHR) of the patient, and the record of side effects is included in a Physician's Desk Reference (PDR) database.
